(19) United States
(12) Patent Application Publication
(10) Pub. No.: US 2013/0232432 A1
(43) Pub. Date: Sep. 5, 2013

(54) PORTABLE CONSOLE, WORKSTATION AND RADIOGRAPHY SYSTEM

(71) Applicants: Min Liu, Beijing (CN); Lei Jia, Tianjin (CN); Li Shao, Beijing (CN); Yi Yan, Beijing (CN); Siyu Huang, Beijing (CN)

(72) Inventors: Min Liu, Beijing (CN); Lei Jia, Tianjin (CN); Li Shao, Beijing (CN); Yi Yan, Beijing (CN); Siyu Huang, Beijing (CN)

(21) Appl. No.: 13/600,413

(22) Filed: Aug. 31, 2012

(30) Foreign Application Priority Data
Aug. 31, 2011 (CN) 201110289148.8

(51) Int. Cl. G06F 19/00

(52) U.S. Cl. CPC G06F 19/00
USPC 715/771

(57) ABSTRACT

A portable console communicates with a workstation of a radiography apparatus to allow a user to control the radiography apparatus via the portable console, the portable console comprising a user interface representing module configured to provide a user operation interface whereby the user inputs a user request, and configured to present a result returned from the workstation to the user, and a user interface service logical module configured to perform a protocol encapsulation and conversion on the user request according to a predefined communication protocol, to send the user request to the workstation, to receive the result returned from the workstation, and to perform a protocol conversion on the received result before sending the result to the user interface representing module.

### BACKGROUND OF THE INVENTION

Embodiments of the present invention generally relate to the field of digital radiography systems, and more particularly to a portable console and a workstation for use with a radiography apparatus, and to a radiography system.

The current digital radiography products mainly include an image chain portion and an operation console portion (abbreviated as “console”), wherein the console is to control the entire image chain portion and to provide a user interactive interface. In the prior art, the console, integrated with a workstation, is deployed at a fixed location and is not movable. A structural diagram of an existing console is shown in FIG. 1. As is shown, the console mainly comprises a user interaction control logical module 1, a position controller control module 2, an X-ray generator control module 3, a detector control module 4 and a workflow control module 5, wherein the position controller control module 2 is to control a position controller, such as a tube position controller, a sternum stand and the like; the X-ray generator control module 3 is to control an X-ray generator; the detector control module 4 is to control an image detector; the workflow control module 5 is to control communication with Picture Archiving and Communication Systems, Radiology Information System, Hospital Information System, and printing workstations, etc.; the user interaction control logical module 1 is to provide these control modules and the user interface 6 of an end user with a high-level encapsulation, such that the end user is able to control the overall system. FIG. 2 illustrates the structural diagram of the aforesaid user interaction control logical module 1, which mainly includes an event communication pipeline 7, a position control user interface 8, an X-ray generator control user interface 9, a detector control user interface 10, a workflow control user interface 11 and an application control user interface 12. In particular, the event communication pipeline 7 is used for registration, transportation and response for the events between other parts included in the user interaction control logical module; the position control user interface 8 is to provide interaction control logic between the user interface 6 and the position controller control module 2; the X-ray generator control user interface 9 is to provide interaction control logic between the user interface 6 and the X-ray generator control module 3; the detector control user interface 10 is to provide interaction control logic between the user interface 6 and the detector control module 4; the workflow control user interface 11 is to provide interaction control logic between the user interface 6 and the workflow control module 5; and the application control user interface 12 is to provide basic application management function of the system. In addition, as is shown in FIG. 1, the user interface 6 may be a keyboard, mouse, and display, etc.

### BRIEF SUMMARY OF THE INVENTION

According to an embodiment of the present invention, a portable console which communicates with a workstation of a radiography apparatus to allow a user to control the radiography apparatus via the portable console is provided. The portable console comprises a user interface representing module configured to provide a user operation interface whereby the user inputs a user request, and configured to present a result returned from the workstation to the user, and a user interface service logical module configured to perform a protocol encapsulation and conversion on the user request according to a predefined communication protocol, to send the user request to the workstation, to receive the result returned from the workstation, and to perform a protocol conversion on the received result before sending the result to the user interface representing module.

According to an embodiment of the present invention, a workstation for communicating with a portable console operated by a user to control a radiography apparatus is provided. The workstation comprises a control unit configured to perform various controls on the radiography apparatus, and a user interactive engine configured to provide a uniform interactive interface for the control unit to allow direct interaction with the portable console, wherein the portable console communicates with the workstation by directly interacting with the user interactive engine such that the control unit controls the radiography apparatus via the user interactive engine.

According to an embodiment of the present invention, a radiography system is provided. The radiography system comprises a radiography apparatus. The radiography system also comprises a portable console comprising a user interface representing module configured to provide a user operation interface whereby the user inputs a user request, and configured to present a result returned from the workstation to the user, and a user interface service logical module configured to perform a protocol encapsulation and conversion on the user request according to a predefined communication protocol, to send the user request to the workstation, to receive the result returned from the workstation, and to perform a protocol conversion on the received result before sending the result to the user interface representing module. The radiography system further comprises a workstation comprising a control unit configured to perform various controls on the radiography apparatus, and a user interactive engine configured to provide a uniform interactive interface for the control unit to allow direct interaction with the portable console, wherein the portable console communicates with the workstation by directly interacting with the user interactive engine such that the control unit controls the radiography apparatus via the user interactive engine.

### BRIEF DESCRIPTION OF THE DRAWINGS

The present disclosure will be more apparent upon description with reference to the following drawings, in which:

FIG. 1 is a structural diagram of a console according to the prior art;

FIG. 2 is a structural diagram of a user interaction control logical module 1 as shown in FIG. 1;

FIG. 3 is a diagram of a portable console, workstation and part of a radiography apparatus according to an embodiment of the present invention;

FIG. 4 is a diagram of a user interface representing module as shown in FIG. 3, according to an embodiment of the present invention;

FIG. 5 is a diagram of a user interface service logical module as shown in FIG. 3, according to an embodiment of the present invention;

FIG. 6 is a diagram of a user interactive engine as shown in FIG. 3, according to an embodiment of the present invention; and

FIG. 7 is a diagram for signal interaction between the portable console and various modules of the workstation in an exposure process according to an embodiment of the present invention.

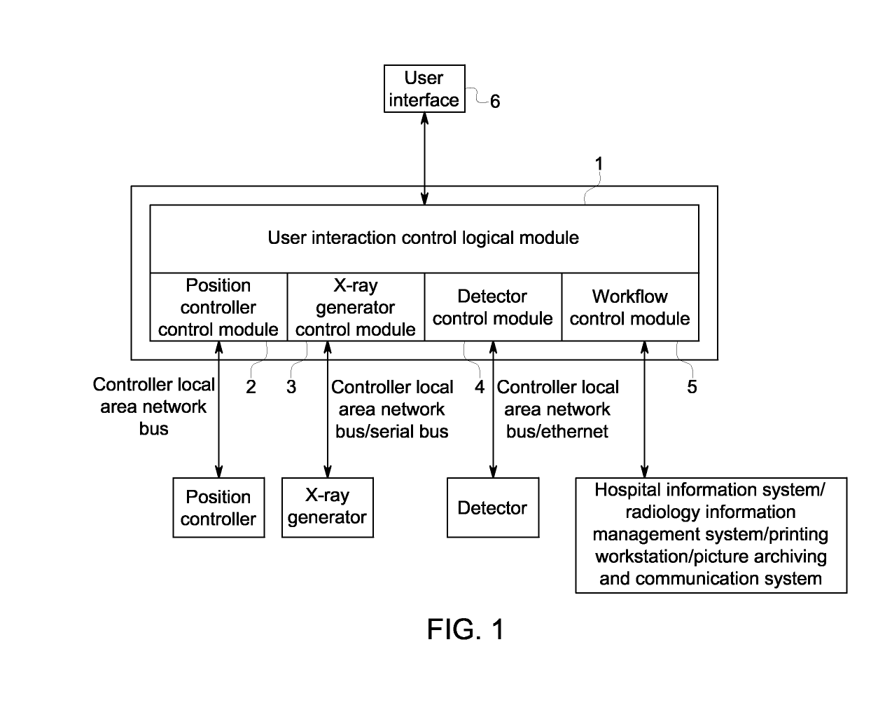

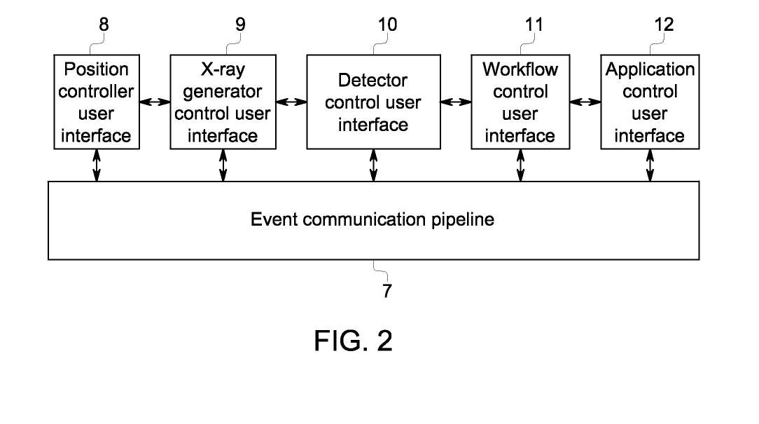

### DETAILED DESCRIPTION OF THE INVENTION

Hereinafter, embodiments of the present invention will be described in details. However, the present invention is not limited to these particular embodiments.

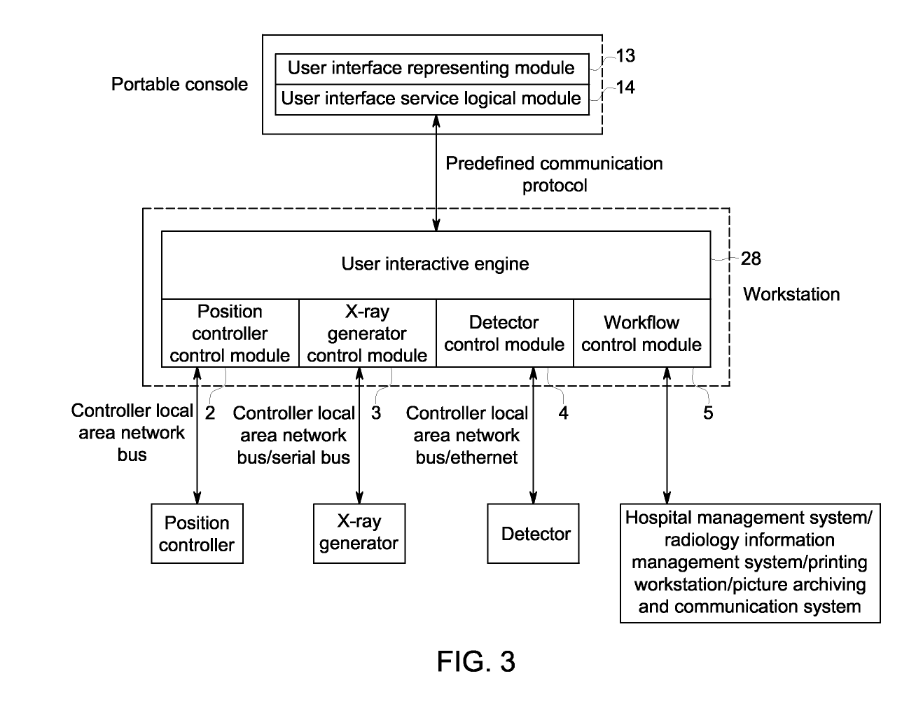

In contrast to the consoles of the existing radiography apparatuses which are integrated into a workstation, embodiments of the present invention provide a portable console that is separated from the workstation and provide a workstation for use with the portable console. FIG. 3 illustrates the diagram of the portable console, workstation and part of a radiography apparatus according to an embodiment of the present invention. As shown in FIG. 3, the portable console is independent of the workstation, but communicates with the workstation via communication links according to a predefined communication protocol. The communication links include the existing wired or wireless communication links and various future communication links to be explored for information transfer and exchange. Using the portable console, the user may input operation instructions (user requests) and review the results returned from the workstation so as to realize control on the radiography apparatus. The portable console transmits the operation instructions to the workstation which controls, based on these instructions, a position controller, an X-ray generator, a detector, and a Hospital Management System/Radiology Information Management System/printing workstations/Picture Archiving and Communication Systems and so on for the radiography apparatus, via links such as a controller local area network bus, a serial bus, Ethernet and the like, or returns the results corresponding to these instructions to the portable console.

The portable console may go anywhere with the user. Therefore, when using the console to control the radiography apparatus, the user does not have to walk constantly back and forth between the examination room and the workstation as that in the prior art. The user only needs to issue commands via the portable console at hand to adjust and control the radiography apparatus. Thereby, the burden on the radiography operators is significantly reduced.

As shown in FIG. 3, the portable console comprises a user interface representing module 13 and a user interface service logical module 14. The user interface representing module 13 provides a uniform operation interface to various control modules for the end user. The user interface representing module 13 provides a user operation interface which allows the user to input user requests, and presents the results from the workstation to the user. The user interface service logical module 14 may encapsulate the instructions from the end user according to predefined rules, and communicate the encapsulated instructions to the workstation according to a predefined communication protocol, so as to control the entire radiography apparatus via various control modules on the workstation.

The end user may control data acquisition, review images, manage the images, control positions and manage basic application settings of the system by the user interface representing module 13.

The user interface service logical module 14 provides user interface services, protocol conversion, network connection and transportation and basic management functions of the console.

The user interface representing module 13 provides a system operation interface for the end user, whereby the end user is allowed to operate the user interface service logical module 14. The user interface service logical module 14 provides corresponding service logic to the user interface representing module 13.

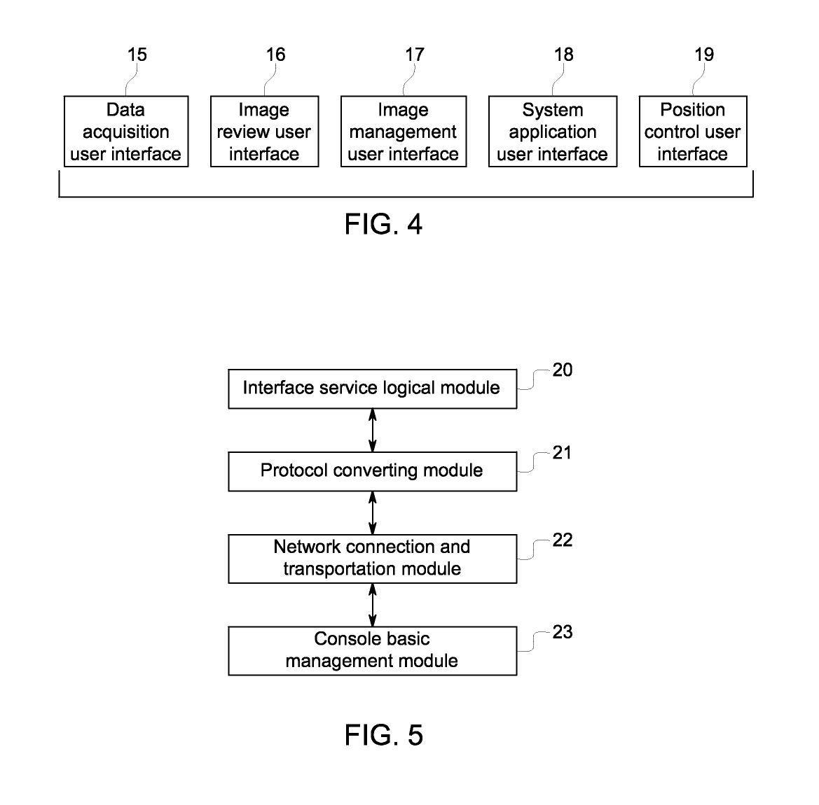

As shown in FIG. 4, the user interface representing module 13 comprises a data acquisition user interface 15, an image review user interface 16, an image management user interface 17, a system application user interface 18 and a position control user interface 19.

The data acquisition user interface 15 provides a user interface for data acquisition. Using this interface, the user may set various parameters for data acquisition, such as an exposure mode (auto-gain exposure mode and a fixed exposure mode), and exposure parameters (voltage, current and exposure time). Then, the data acquisition user interface 15 passes the parameters set by the user to the user interface service logical module 14, which protocol-encapsulates, converts and transfers to the workstation the parameters according to the predetermined protocol, so that the workstation completes data acquisition control process.

The image review user interface 16 provides a user interface for reviewing images. Using this interface, the user may set parameters for reviewing images, for example, to select the number of the image to be reviewed and how the image is to be reviewed. Then, the image review user interface 16 transfers the user settings or selections to the user interface service logical module 14, which protocol-encapsulates, converts and transfers to the workstation the set parameters according to a predetermined protocol, to control the workstation to call in and return the desired image data from the image database. The image data will be delivered to the image review user interface to finally complete the image review process.

The image management user interface 17 provides a user interface for managing images. The user may input various parameters for image management via this interface, such as selection of operations to be performed (modification, deletion, etc.) and the number of the desired image. The image management user interface 17 transfers the parameters set by the user to the user interface service logical module 14, which protocol-encapsulates, converts and transfers to the workstation the parameters according to a predetermined protocol, to control the workstation perform corresponding operations on the designated object (i.e., the image corresponding to the selected number of image) according to the operations selected by the user to complete the image management process.

The system application user interface 18 provides a user interface for management of basic system applications. The user may use this interface to select operation(s) (for example, selection and undo) to be performed on one or more system application options. The system application user interface 18 transfers the user selections to the user interface service logical module 14, which protocol-encapsulates, converts and transfers to the workstation the set parameters according to a predetermined protocol. According to the operations selected by the user, the workstation will perform corresponding operations on the designated system application options (for example, whether to automatically transfer an image to a remote image management workstation, whether to automatically obtain a list of patients from a remote Radiology Information Management System, etc.) to complete the management of the basic system applications.

The position control user interface 19 provides a user interface for controlling positions. The user may set, via this interface, parameters associated with position control, such as selection of three-dimensional relative coordinates or a slanted angle, etc. of the position controller. Then, the position control user interface 19 transfers the parameters set by the user to the user interface service logical module 14, which protocol-encapsulates, converts and transfers to the workstation the set parameters according to a predetermined protocol, such that the workstation completes the position control process.

In addition, as shown in FIG. 5, the user interface service logical module 14 further comprises an interface service unit 20, a protocol converting unit 21, a network connection and transportation unit 22 and a console basic management unit 23. The interface service unit 20 provides interface service logic to the user interface representing module 13. To be specific, the interface service unit 20 receives the parameters set by the user transmitted from the user interface representing module 13 or the data transmitted from the protocol converting unit 21, and subsequently verifies the validity of the data. The interface service unit 20 also establishes different control branches for different user requests (data acquisition, image review, image management, system applications and position control) so as to realize bi-directional communication between the user interface representing module 13 and the user interface service logical module 14. The establishment of different control branches means that the interface service unit 20 defines a proper signal transportation path according to a specific user request such that the signal is communicated between the units or modules pertinent to that user request, to implement particular control on the radiography apparatus. For example, if a user sends a request to acquire data, the interface service unit 20 establishes a control branch for data acquisition such that the signal is communicated between the units or modules associated with the data acquisition, rather than units or modules that are irrelevant to the data acquisition.

The protocol converting unit 21 provides conversion of data formats and network protocols for the data from the interface service unit 20 and the network connection and transportation unit 22.

The network connection and transportation unit 22 provides network connection, network transportation and network link maintenance for the console.

The console basic management unit 23 provides basic management functions at a platform level of the console for the interface service unit 20, the protocol converting unit 21 and the network connection and transportation unit 22.

Besides, the portable console according to an embodiment of the present invention may further comprise a reader (not shown) for reading the card storing patient information or information on other carriers, and sending the read information to the user interface representing module 13 to present to the user. For example, the card and the other carriers include, but are not limited to, a barcode, a radio frequency identity label, and IC card, etc. For example, the reader includes, but is not limited to, a barcode reader, an RFID reader, an IC card reader and a scanner, etc.

Though it is not shown, one skilled in the art would appreciate that the portable console may further comprise an input/output device, such as buttons, keyboards, display screen and so on. These input/output devices corporate with the user interface representing module 13 to enable input of user requests and display of the returned results.

FIG. 3 further illustrates a structural diagram of a workstation according to an embodiment of the present invention. The workstation communicates with the portable console described above to control the radiography apparatus. As shown in FIG. 3, the workstation comprises a control unit and a user interactive engine 28, wherein the control unit comprises a plurality of control modules to perform different control functions, such as a position controller control module 2, an X-ray generator control module 3, a detector control module 4, and a workflow control module 5.

The user interactive engine 28 provides a uniform interactive interface for various control modules to facilitate interaction with the portable console. The user interactive engine 28 provides uniform encapsulation for various control modules (including the position controller control module 2, the X-ray generator control module 3, the detector control module 4, and the workflow control module 5). The user or the portable console directly interacts with the user interactive engine 28 only, without need for direct interaction with each of these internal control modules. In this way, various controls such as the position controller control, the X-ray generator control, detector control and the workflow control can be isolated. The user interactive engine 28 hides, from the portable console, the details of operation processes of the underlying position controller control module 2, the X-ray generator control module 3, the detector control module 4, and the workflow control module 5, to provide the portable console with a uniform and predefined operation interface adapted to control the position controller, the X-ray generator, the detector, and the workflow, so as to provide the portable console with functions such as event response, data transportation, state monitoring, and system management.

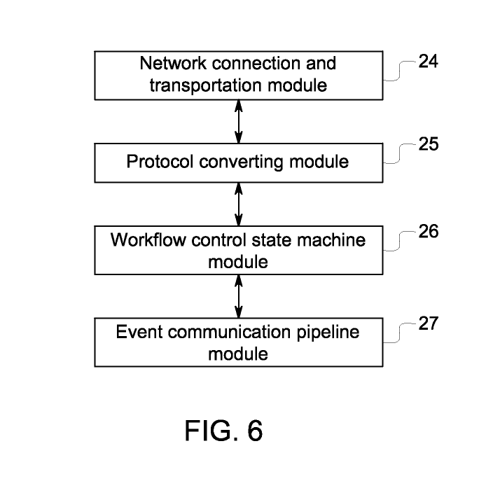

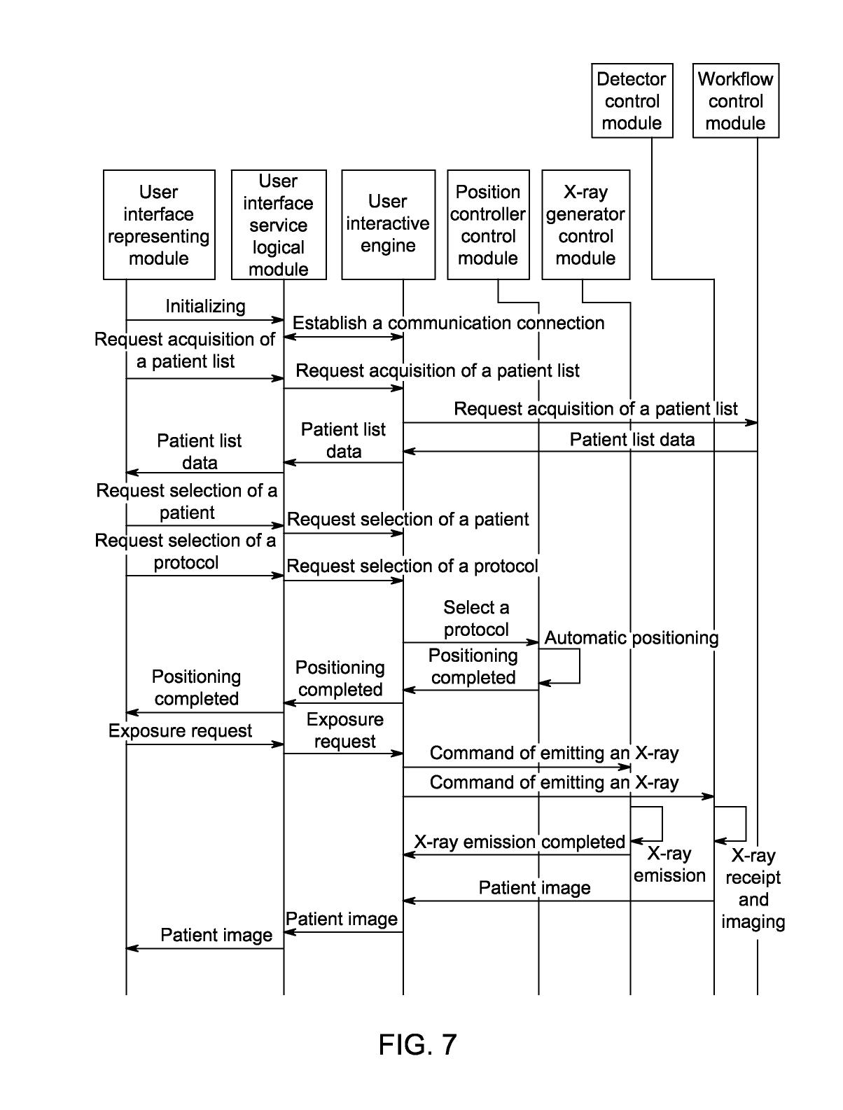

FIG. 6 shows that the user interactive engine 28 further comprises a network connection and transportation unit 24, a protocol converting unit 25, a workflow control state machine 26 and an event communication pipeline 27.

The network connection and transportation unit 24 provides network connection, network transportation and network link maintenance functions; the protocol converting unit 25 provides data formats and network protocol conversion functions; the workflow control state machine 26 controls the switching between workflow states, maintains the state machine, and provides simple state correction functions; the event communication pipeline 27 is responsible for event registration, transmission and responses between different modules.

Hereunder, an embodiment with respect to the interactions between the portable console, the workstation and the radiography apparatus is described in details.

Take an exposure process as an example. As shown in FIG. 6, firstly, the workstation and the portable console are started with initialization and system self-test, establishment of communication connection between them. The user operates the portable console to input a request “Acquiring a Patient List” through the user interface representing module. The user interface service logical module performs protocol encapsulation and conversion on the request according to a predetermined protocol, and then sends the request to the user interactive engine of the workstation. The user interactive engine performs protocol conversion on the request and sends the request to the workflow control module. Under the control of the workflow control module, the workstation searches the database for the desired patient list, and encapsulates and converts the patient list according to a designated protocol and sends it to the portable console by the user interactive engine. The user interface service logical module of the portable console performs protocol conversion on the patient list and transmits it to the user interface representing module. The user interface representing module displays the patient list on an operation interface, on which the user may select a patient, a desired examination protocol, or set the corresponding exposure parameters, and then issue an exposure command via the user interface representing module. The user interface service logical module of the portable console will then encapsulate the information according to the designated protocol, and send it to the workstation together with the exposure command. After receiving this information and the exposure command, the user interactive engine performs a protocol conversion thereon and transmits them to the corresponding control modules, to control the position controller, the X-ray generator, the detector and the workflow on the radiography apparatus to complete the exposure process and obtain the examination images of the patient. Thereafter, the workstation sends the obtained examination image of the patient to the portable console and records this exposure process. Upon receipt of the examination image of the patient, the user interface service logical module of the portable console performs a protocol conversion on the image and sends the image to the user interface representing module for display on the operation interface. So far, the exposure is completed.

The embodiments of the present invention have been described with reference to the drawings hereinabove. However, one skilled in the art may make various modifications, changes and equivalent substitutions to embodiments of the present invention without departing from the spirit and scope of the present invention. These various modifications, changes and equivalent substitutions are intended to be within the spirit and scope defined by the appended claims.

When designing the consoles of existing radiography apparatuses, network control is not considered, such that these existing apparatuses do not support remote control ability. Besides, these existing consoles are integrated with the workstation generally outside of the examination room, and therefore are large and clumsy in size and hard to be carried around. The radiography operators have to walk constantly back and forth between the examination room and the workstation, when operating the radiography apparatus via the console (for example, to position the patient, or select a protocol). This repeated walking brings huge workload for the radiography operators especially the ones who have to operate a large amount of examinations every day.

To address one or more of the aforesaid problems, according to an embodiment of the present invention, a portable console is provided, wherein the portable console communicates with a workstation of a radiography apparatus to allow the user to control the radiography apparatus via the portable console. The portable console comprises a user interface representing module adapted to provide a user operation interface whereby the user inputs an user request, and to present a result returned from the workstation to the user, and a user interface service logical module adapted to perform a protocol encapsulation and conversion on the user request according to a predefined communication protocol and send the user request to the workstation, and adapted to receive the result returned from the workstation and perform a protocol conversion on the received result before sending the result to the user interface representing module.

According to an embodiment of the present invention, the user interface representing module comprises a data acquisition user interface, an image review user interface, an image management user interface, a system application user interface and a position control user interface.

According to an embodiment of the present invention, the user interface service logical module comprises an interface service unit, a protocol converting unit, a network connection and transportation unit and a console basic management unit, wherein the interface service unit receives the user request transmitted from the user interface representing module or data from the protocol converting unit, verifies the data, and establishes different control branches for different user requests so as to realize bi-directional communication between the user interface representing module and the user interface service logical module, the protocol converting unit provides conversion of data formats and network protocols for the data from the interface service unit and the network connection and transportation unit, the network connection and transportation unit provides network connection, network transportation and network link maintenance for the console, and the console basic management unit provides basic management functions at a platform level of the console for the interface service unit, the protocol converting unit and the network connection and transportation unit.

According to an embodiment of the present invention, the portable console further comprises a reader adapted to read information from a carrier storing patient information, and transmit the read information to the user interface representing module.

According to an embodiment of the present invention, the carrier is a barcode, and the reader is a barcode reader.

According to an embodiment of the present invention, the carrier is a radio frequency identity label, and the reader is a radio frequency reader.

According to an embodiment of the present invention, the carrier is an IC card, and the reader is an IC card reader.

According to an embodiment of the present invention, a workstation is provided, which communicates with a portable console operated by a user to control a radiography apparatus, the workstation comprising a control unit adapted to perform various control on the radiography apparatus, and a user interactive engine adapted to provide an uniform interactive interface for the control unit to allow direct interaction with the portable console, wherein the portable console communicates with the workstation by only directly interacting with the user interactive engine such that the control unit controls the radiography apparatus via the user interactive engine.

According to an embodiment of the present invention, the control unit comprises a position controller control module, an X-ray generator control module, a detector control module and a workflow control module.

According to an embodiment of the present invention, the user interactive engine comprises a network connection and transportation unit, a protocol converting unit, a workflow control state machine, and an event communication pipeline, wherein the network connection and transportation unit provides network connection, network transportation and network link maintenance, the protocol converting unit provides conversion of data formats and network protocols, the workflow control state machine controls switching of workflow states, maintains the state machine, and provide simple state correction function, and the event communication pipeline facilitates event registration, transportation and responses between different modules.

According to an embodiment of the present invention, a radiography system is provided, comprising a radiography apparatus, a portable console as discussed above and a workstation as discussed above.

In the consoles of the existing radiography apparatuses, various parts of the user interaction control module 1 are coupled to each other too closely to allow the addition or update of functional module(s). However, the portable console and the workstation according to an embodiment of the present invention can clearly separate the user interface representing portion from the user interface control logic portion, to facilitate adding or updating the functional module(s).

Furthermore, the portable console according to an embodiment of the present invention is relatively small and light, and thus is convenient to carry around. Besides, the portable console, workstation and radiography system according to embodiments of the present invention allow and facilitate remote control.

What is claimed is:

1. A portable console which communicates with a workstation of a radiography apparatus to allow a user to control the radiography apparatus via the portable console, the portable console comprising:
a user interface representing module configured to provide a user operation interface whereby the user inputs a user request, and configured to present a result returned from the workstation to the user; and
a user interface service logical module configured to perform a protocol encapsulation and conversion on the user request according to a predefined communication protocol, to send the user request to the workstation, to receive the result returned from the workstation, and to perform a protocol conversion on the received result before sending the result to the user interface representing module.

2. The portable console according to claim 1, wherein the user interface representing module comprises:
a data acquisition user interface;
an image review user interface;
an image management user interface;
a system application user interface; and
a position control user interface.

3. The portable console according to claim 1, wherein the user interface service logical module comprises:
an interface service unit;
a protocol converting unit;
a network connection; and
transportation unit and a console basic management unit,
wherein:
the interface service unit receives the user request transmitted from the user interface representing module or data from the protocol converting unit, verifies the data, and establishes different control branches for different user requests so as to realize bi-directional communication between the user interface representing module and the user interface service logical module,
the protocol converting unit provides conversion of data formats and network protocols for the data from the interface service unit and the network connection and transportation unit,
the network connection and transportation unit provides network connection, network transportation and network link maintenance for the console, and
the console basic management unit provides basic management function at a platform level of the console for the interface service unit, the protocol converting unit and the network connection and transportation unit.

4. The portable console according to claim 2, further comprising a reader configured to read information from a carrier storing patient information, and to transmit the read information to the user interface representing module.

5. The portable console according to claim 4, wherein the carrier is a barcode and the reader is a barcode reader.

6. The portable console according to claim 4, wherein the carrier is a radio frequency identity label and the reader is a radio frequency reader.

7. The portable console according to claim 4, wherein the carrier is an IC card and the reader is an IC card reader.

8. A workstation for communicating with a portable console operated by a user to control a radiography apparatus, the workstation comprising:
a control unit configured to perform various controls on the radiography apparatus; and
a user interactive engine configured to provide a uniform interactive interface for the control unit to allow direct interaction with the portable console,
wherein the portable console communicates with the workstation by directly interacting with the user interactive engine such that the control unit controls the radiography apparatus via the user interactive engine.

9. The workstation according to claim 8, wherein the control unit comprises:
a position controller control module;
an X-ray generator control module;
a detector control module; and
a workflow control module.

10. The workstation according to claim 8, wherein the user interactive engine comprises:
a network connection and transportation unit;
a protocol converting unit;
a workflow control state machine; and
an event communication pipeline,
wherein:
the network connection and transportation unit provides network connection, network transportation and network link maintenance,
the protocol converting unit provides conversion of data formats and network protocols,
the workflow control state machine controls switching of workflow states, maintains the state machine, and provide simple state correction function, and
the event communication pipeline facilitates event registration, transportation and responses between different modules.

11. A radiography system, comprising:
a radiography apparatus;
a portable console comprising:
a user interface representing module configured to provide a user operation interface whereby the user inputs a user request, and configured to present a result returned from the workstation to the user; and
a user interface service logical module configured to perform a protocol encapsulation and conversion on the user request according to a predefined communication protocol, to send the user request to the workstation, to receive the result returned from the workstation, and to perform a protocol conversion on the received result before sending the result to the user interface representing module; and
a workstation comprising:
a control unit configured to perform various controls on the radiography apparatus; and
a user interactive engine configured to provide a uniform interactive interface for the control unit to allow direct interaction with the portable console,
wherein the portable console communicates with the workstation by directly interacting with the user interactive engine such that the control unit controls the radiography apparatus via the user interactive engine.
